(19) United States
(12) Patent Application Publication
(10) Pub. No.: US 2026/0258850 A1
(43) Pub. Date: Sep. 3, 2026

(54) IMPROVED GEOPOLYMERIC FRICTION MATERIAL, IN PARTICULAR FOR MANUFACTURING BRAKE PADS, AND ASSOCIATED METHOD AND BRAKE PAD

(71) Applicant: ITT Italia S.R.L., Lainate (IT)

(72) Inventors: Agustin SIN XICOLA, Barge (IT); Francesco VANNUCCI, Barge (IT); Alberto CONTE, Barge (IT); Lorenzo LATTANZI, Barge (IT); Useche DOS SANTOS INCHAUSPE, Barge (IT); Paolo COLOMBO, Barge (IT)

(73) Assignee: ITT Italia S.R.L., Lainate (IT)

(21) Appl. No.: 18/876,136

(22) PCT Filed: Jun. 21, 2023
(86) PCT No.: PCT/IB2023/056418

§ 371 Date: Dec. 17, 2024

(30) Foreign Application Priority Data
Jul. 1, 2022 (IT) 102022000014038

(51) Int. Cl. F16D 69/02; C04B 14/48; C04B 16/12; C04B 28/00; C04B 111/00; C04B 111/12

(52) U.S. Cl. CPC F16D 69/028; C04B 14/48; C04B 16/12; C04B 28/006; C04B 2111/00362; C04B 2111/12; F16D 2200/0043

(57) ABSTRACT

A friction material for brake elements and an associated method wherein inorganic and/or organic and/or metallic fibers, at least one binder, at least one friction modifier or lubricant, and at least one filler or abrasive are mixed together, the binder being made up at least 90% w of at least one amorphous geopolymer containing aluminosilicates of at least two different alkali metals, the alkali metals being selected at couples of different metals in the group consisting in: Na, K, Li, Ce, Rb.

### CROSS-REFERENCE TO RELATED APPLICATIONS

This Patent application claims priority from Italian Patent Application No. 102022000014038 filed on Jul. 1, 2022, the entire disclosure of which is incorporated herein by reference.

### TECHNICAL FIELD

The present invention relates to an improved geopolymeric friction material, specifically designed for the manufacture of brake pads and to a method for the preparation thereof. The invention also relates to an associated brake pad manufactured using the improved friction material prepared through such a method.

The friction material of the invention is specifically intended for the manufacture of non-asbestos friction layers/blocks for friction elements such as braking elements, i.e. vehicle brake pads or shoes, and/or friction discs, having performance similar to or better than those belonging to the NAO (“Non-Asbestos Organic friction material”), “Low Steel” and “Semi-met” classes of friction materials.

### TECHNICAL BACKGROUND

Published application EP3128201 In the name of the same Applicant, the whole content of which is incorporated herein by reference for the necessary parts thereof, discloses a method for obtaining a binder for brake pads, constituted for at least the 90% by a geopolymer, as well as an associated friction material and brake pad.

In EP3128201 the binder is obtained by dry grinding caustic soda flakes and subsequent dry mixing of the soda powder with kaolin. This procedure, though being chemically efficient, involves a not-insignificant series of potential safety risks to operator.

In order to overcome this problem, EP3841311 still in the name of the same Applicant, the whole content of which is also incorporated herein by reference for the necessary parts thereof, discloses a similar process but working with metakaolin instead of kaolin, and with an aqueous sodium silicate solution with a minimum of sodium hydroxide, which can in any case be used as a reactant.

According to EP3841311, other sources of aluminum silicates can be used in addition to metakaolin, such as kaolin or fly ash. However, kaolin has long reaction times, while one negative aspect of fly ash is the fact that suppliers do not provide unvarying composition over time. Accordingly, metakaolin is preferred.

Still according to EP3841311, other raw materials may be used, e.g. a generic source of silica, such as quartz, or colloidal silica dissolved in a basic sodium or potassium hydroxide solution, under suitable conditions. In this manner, either sodium based or potassium based geopolymers are obtained.

In any event, EP3841311 teaches a process wherein a wet mortar, produced by adding the above-mentioned solution of alkali silicate to metakaolin by mechanical mixing to form a slurry, is subsequently dried through an atmospheric pressure drying process, to form a tape of dried or partially dried geopolymer, which has still to be consolidated, having been subjected to a loss of weight of 5% to 40% from the original weight and having a related residual moisture less than 30% in final weight. This product is then ground until sizes less than or equal to 800 microns, preferably less than 400 microns, and the resulting powdered material is used as a binder for the production of mix/compositions for brake pads similar to those as disclosed in EP3128201.

Subsequent tests carried out by the technical people of the Applicant have now shown that the chemical nature of the alkali silicate solution is not indifferent both on the final performances of the friction material mix and on the efficiency and easiness of production of the blocks of friction material for braking applications.

In particular, it has been revealed that the thermal resistance of the sodium only based geopolymers shows limits under high temperature and high braking stress conditions, as evidenced during braking tests carried out on vehicles (i.e. Hot Judder, High Speed Fading).

On the contrary, potassium only based geopolymers, when used as binders for friction material pads/blocks, do not present the hot judder phenomenon, but give rise to some difficulties having regard the production of the geopolymer itself; in particular its rheology is not too easy to be adjusted, and the direct consequence could be more brittle tape with more cracks after the drying process.

### SUMMARY OF THE INVENTION

The object of the present invention is to provide a friction material having a binder entirely or almost entirely constituted by a geopolymer and overcoming the drawbacks of the prior art as disclosed above. It is in particular an object of the invention to provide a friction material of the kind as disclosed in EP3841311, which is at the same time easy to be produced and hardly subjected to operational problem when heated or overheated.

It is also an object of the Invention to provide a method to improve the rheology and the production process of the geopolymer.

It is also an object of the invention to provide a method for manufacturing such a friction material and friction layers/blocks made therefrom, which method avoid or at least limit the issues during high thermal stress tests such Hot Judder, Fading and other similar tests.

It is a further object of the invention to provide braking elements, e.g. vehicle brake pads or shoes, which are obtained with the above methods.

The invention therefore relates to a friction material having a binder formed entirely or almost entirely by a geopolymer, to a method for producing such a friction material and layers/blocks for friction elements such as braking elements, e.g. vehicle brake pads or shoes, as defined in the appended claims.

The Invention also relates to an associated geopolymeric binder adapted to be used for manufacturing friction layers/blocks, particularly for brake pads or shoes, made of a friction material produced with the method of the invention.

In particular, the friction material according to the invention is based on the mixing of sodium and potassium based geopolymer to improve the geopolymer production owing to the rheological properties of sodium based geopolymer and, altogether, the thermal resistance during high stress episodes such downhill descent, typical of potassium based geopolymers.

The friction material according to the invention includes as its component materials; inorganic and/or organic and/or metallic fibers; a binder that is almost entirely or completely and exclusively constituted by a geopolymer or by a mix of geopolymers; at least one friction modifier or lubricant, e.g. including sulfurs and/or a carbonic material or nanomaterial; and at least one inorganic or metallic filler or abrasive, wherein, however, the principal abrasive work in the friction material of the invention is done by the geopolymeric matrix of the pads generated by the binder.

Henceforth, “binder almost entirely constituted by a geopolymer” refers to a binder for friction elements in which a geopolymer or a geopolymer composition or mix constitutes at least 90% in weight (90% wof the total quantity of binder present).

The geopolymeric binder is, preferably but not necessarily, present in the composition of friction material according to the invention in a quantity equal to or greater than 5% in weight, or even more preferably comprised between 20% and 60% in weight, calculated on the total weight of the friction mix/composition. In fact, experiments have shown that with too small a quantity of inorganic binder, depending on the type of geopolymer used as a binder and the nature of the other materials used in the composition, the mechanical characteristics necessary for its use as a friction material cannot be achieved.

The friction material according to the invention is therefore almost completely or totally lacking organic binders (which may be present at maximum in a quantity equal to or less than 10% in weight) and for this reason cannot be subject to heat degradation through oxidization at high temperatures, e.g., greater than 300° C., and up to beyond 600° C.

The geopolymeric binder of the invention is used in a friction material according to the invention as the single and principal binder and, therefore, prevalent (i.e., making up at least 90% of the total binder present), in the complete or near-complete absence of traditional organic binders, is obtained through a chemical reaction starting from inorganic precursors such as SiO₂ and Al₂O₃.

According to the main feature of the invention, the geopolymeric binder to be used in a friction material according to the invention as the single or principal binder, is obtained specifically by using in combination commercial sodium and potassium silicates, for example from the company “PQ Corporation-Holland” and/or “Tillmanss”, possibly with the addition of a small quantity of sodium and/or potassium hydroxide (it also works in any case with a near-complete absence of hydroxides), and commercial metakaolin, for example, metakaolin obtained through the high-temperature calcining of kaolin from the company “Imerys Refractory Minerals—Argical-M 1200S”, metakaolin containing in weight approximately 55% SiO₂ and 39% Al₂O₃, plus Fe₂O₃, TiO₂, K₂O, Na₂O, Cao, and MgO impurities, which is generally assumed to have the following general chemical formula:

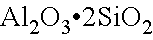

The inorganic geopolymeric binder according to the invention may be prepared in pre-mixed form and then joined as such to all the other component materials of the mix of friction material, preferably in a Loedige mixer or in any of the other mixers commonly used for friction materials, e.g. Henschel or Eirich mixer. The unfinished compound thus obtained then undergoes a molding process to produce the desired friction element, e.g., brake pads or blocks.

According to an alternative embodiment, the inorganic geopolymeric binder according to the invention may be prepared during the mixing step of the whole friction composition, to give rise directly to the raw friction compound to be subsequently molded in a block of friction material having the desired properties.

### Synthesis of Geopolymeric Binder

Similar to the method of EP3841311, the geopolymeric binder to be used in the friction compositions for braking elements is prepared from metakaolin which is made to react with an aqueous solution of soda and/or caustic potash, preferably used in combination with each other, with the addition to caustic solutions of sodium and potassium disilicates in combination to each other, bringing to the formation of an amorphous mixed geopolymer of sodium and potassium.

A basic aqueous sodium silicate and potassium silicate solutions are firstly formed (e.g. by addition of caustic soda and caustic potash), dissolving any form of sodium and potassium silicate in water, with the possible addition of commercial sodium and/or potassium hydroxide pellets. Metakaolin is then added to this basic aqueous solution, all at once or gradually while mixing, or, vice versa, the basic silicate solution is gradually added to the metakaolin powder, until a homogeneous paste is obtained with a relatively high SiO₂/Al₂O₃ ratio, kept in the range/interval between 3 and 10, i.e., given “x” being the molar ratio SiO₂/Al₂O₃, the valid ratio must be:

$$3 < x < 10$$

This wet paste, similar to a slurry, is taken from the mixer and undergoes a step of forming and drying in any atmospheric regime (so even under vacuum) in any temperature regime up to 300° C., using an appropriate forming and drying system, preferably a tape casting device, such as that one shown (schematically only) in the published Italian patent application No. 102020000015202.

As already disclosed in this published Italian patent application, the mixing of the silicate solution and the metakaolin may include one mixing at a speed between about 500 rpm and about 1000 rpm and for a time between about 1 minute and about 20 minutes.

The mixing of the caustic silicate solution and the metakaolin may be carried out at a temperature between about 20° C. and about 40° C.

Thereafter, the wet paste/slurry so obtained and exiting from the mixer is spread on a support to form a layer of homogeneous thickness and subjected to a thermal treatment in which it is dried to obtain a tape made of dried/semi-dried geopolymeric material.

The dried tape may have a moisture content of any value comprised between 0% w to 20% w and a thickness between about 0.1 mm and about 2 mm. The support may consist of paper, a plastic film or a steel sheet. For instance, the support may consist in Sappi® paper or in a Coveme® film.

More generally, according to the present invention, the support, e.g. in the form of an endless belt conveyor, may be made of specific material not sensitive to the basic atmosphere, suitable for neutral or alkaline pastes/mortars, e.g. Mylar or other types of materials suitable for neutral/alkaline pastes/mortars. During forming and drying of the paste into a tape, the geopolymerization reaction occurs, in which the metakaolin is dissolved in the alkaline sodium and potassium silicate solution. The oligomers formed then condense together to create the 3D geopolymer network.

The drying step is preferably carried out in a controlled temperature oven (single or multistage oven), where the controlled temperature oven can have a temperature profile adapted by means of a control device. The drying step may be carried out in a discontinuous or continuous manner. When carried out in a continuous manner, a tunnel oven/furnace may be used crossed by the layer of wet paste spread on the support.

Preferably, the final moisture content of the geopolymeric binder of the invention is to be comprised between 4% w and 16% w of the total weight of the mixed geopolymer, and even more preferably between 8% w and 12% w.

The dried aggregate in the shape of a tape exiting the oven and formed by an amorphous geopolymer is ground and reduced to powder, using any suitable grinding system, preferably an hammer mill, or ball grinder or jar mill, until granulometry of less than 600 microns is obtained, preferably less than 400 microns.

Thereafter, the so obtained powder made of a mixed double alkali, preferably sodium/potassium, geopolymer, is mixed with the other usual component materials of friction compositions, such as fillers, lubricants, abrasives, fibers, etc., in proportions similar to those as adopted in any of the known friction material classes as NAO, Semi-Met and LS (Low Steel)—with the only trick of reducing the strong abrasive components-obtaining a friction material mixture that is molded as in EP3128201.

During molding, simply due to the application of pressure and temperature, the previously-synthesized geopolymer particles consolidate and remain amorphous, resulting in a friction element, typically a brake pad, in which the component materials are dispersed into a matrix constituted solely by a mixture of amorphous sodium and potassium geopolymerized inorganic binder (except for possible limited quantities, less than 10%, of organic binder).

The friction elements thus obtained do not produce waste due to cracks or flaking, the tape obtained from the alkaline slurry is substantially free of cracks and sufficiently resilient to be easily managed and the final result is a reconsolidation of the powder under molding conditions comparable to EP3841311 and under the normal molding conditions of brake pads, producing braking elements having performance comparable to those made of the friction materials produced according to the hydrothermal synthesis of EP3841311, with material and disc wear also comparable and which are however free or substantially free from the high thermal stress, such hot judder phenomenon, for example.

### Molding for Reconsolidation of Geopolymer Powder

The molding of the brake pads obtained with the method of the invention is done by placing the double alkaline raw compound (friction mix) into a mold which also has a metallic support or backplate, property treated and with or without a known damping/insulating layer, called the “underlayer”, which during the molding stage not only forms the layer or block of friction material, possibly over the underlayer when present, but also achieves adhesion of this layer or block to the metallic support.

The molding is done working at temperatures between 4° and 250° C. and at a pressure from 50 to 2000 Kg/cm2 for a time between 1 and 30 minutes, or preforming the raw double alkaline compound or mix into a mold and then molding the pre-formed compound on the backplate at a temperature of 40 to 250° C. at a pressure of 150 to 2000 kg/cm2 (14.7 to about 200 MPa) for a period of from 1 to 15 minutes.

Alternatively, the double alkaline raw compound can be molded to obtain the friction material block, which is only then connected to the metallic support or backplate (with or without underlayer), for example using phenolic or silicone-based glue.

### Other Components of the Friction Material

The components of the composition or raw compound of friction material to be produced according to the invention can be the components used in the friction materials already known in the technique, with the sole precaution to completely or almost completely replace the current organic binders with the inorganic binder obtained with the method as described above, simultaneously reducing the content of abrasives and increasing the content of lubricants.

The friction material obtainable according to the invention is also preferably free of copper and/or its alloys, both in powder and fiber form.

In particular, the component made of fiber may consist of any organic or inorganic fiber other than asbestos, or in any metallic fiber commonly used in friction materials, preferably excluding copper and its alloys. Illustrative examples include inorganic fibers such as glass fibers, wool or rock fiber, wollastonite, sepiolite and attapulgite, and organic fibers such as aramid fibers, polyimide fibers, polyamide fibers, phenolic fibers, cellulose and acrylic fibers or PAN (Polyacrylonitrile), metallic fibers such as steel fibers, stainless steel, aluminum fibers, zinc, etc.

Fibers may be used in the form of short fibers or powder.

The quantity of fiber is preferably between 2% in volume and 30% in volume out of the total volume of friction material and more preferably between 8% and 15% in volume and the fibrous component preferably always includes rock fiber, which has been shown to have a strong affinity with the geopolymers used as binder.

Numerous materials known in the technique can be used as organic or inorganic fillers. Illustrative examples include precipitated calcium carbonate, barium sulphate, magnesium oxide, calcium hydroxide, calcium fluoride, slaked lime, talc, mica.

These can be used alone or in combinations of two or more. The quantities of these fillers is preferably between 2% to 40% in volume based on the total composition of the friction material.

The friction modifier (which could include all or part of the filler) can include, in addition to carbonic materials or nanomaterials such as graphene, an organic filler such as cashew dust, rubber dust, powdered tread rubber, a variety of unvulcanized rubber particles, a variety of vulcanized rubber particles, an inorganic filler such as barium sulphate, calcium carbonate, calcium hydroxide, vermiculite and/or mica, an abrasive such as silicon carbide, alumina, zirconium silicate, metal sulfide-based lubricant such as molybdenum disulphide, tin sulfide, zinc sulfide, iron and non-ferrous sulfides, metal particles other than copper and copper alloys, and/or a combination of the above.

Abrasives can be classified as follows (the list below is only indicative, not necessarily exhaustive and not limiting):
Mild Abrasives (Mohs 1-3): talc, calcium hydroxide, potassium titanate, mica, kaolin, vermiculite;
Medium Abrasives (Mohs 4-6): barium sulphate, magnesium oxide, calcium fluoride, calcium carbonate, wollastonite, calcium silicate, iron oxide, silica, chromite, zinc oxide;
Strong Abrasives (Mohs 7-9): silicon carbide, zircon sand (zirconium oxide), zirconium silicate, zirconium, corundum, alumina, mullite.

Preferably, but not necessarily, the friction material obtainable according to the invention does not contain strong abrasives but only medium or mild abrasives, since the geopolymer produced as binder already is, in itself, a medium abrasive.

The friction material produced according to the invention may also preferably include graphite, in a quantity between 5% and 15% in volume based on the total composition of the friction material.

The total content of lubricants, according to desired friction characteristics, may be preferably between 4% and 20% of the entire volume of friction material, and can include graphene in particular,

### Curing and Painting

The molded article Item (brake pad), which was cured during pressing and generally already usable after this simple press molding, is optionally, when required by the formulation and/or by the design specifications, further post-cured through supplementary heat treatment from 80 to 450° C. for between 10 minutes and 15 hours, then spray- or powder-painted, oven dried and possibly mechanically processed where necessary to produce the finished product.

The friction material obtained with the method of the invention, both after simple press molding and after possible optional supplementary heat treatment, can be used in applications such as disc brake pads, shoes, and linings for cars, trucks, train cars and various other types of vehicles and industrial machines, or in clutch discs.

According to further aspects of the invention, to obtain the best results the optimal geopolymer composition field corresponds to a molar ratio between the alkali metals content and the aluminum content equal to 1, i.e., it has to be verified the formula:

$$R / Al = 1 \qquad [ 1 ]$$

wherein R=sum of the content of Na plus K.

However, since the gist of the invention is the combination of Na and K, it is clear that the invention may extend to any combination of two alkali metals different from each other and even other than Na and K, operating using similar proportions.

In any event, it is even possible to operate outside the above relation, I.e., wherein:

$$R / Al \neq 1 \qquad [ 2 ]$$

Preferably, however, the following formula [1′] is to be verified:

$$R / Al = 0.8 < x < 1.2 \qquad [ {1}^{′} ]$$

Still according to preferred embodiments of the invention the molar content in potassium has to be at least equal to the molar content of sodium, so R=50% Na+50% K, and most preferably, the content in potassium (K) is to be higher than the content in sodium (Na). So, it has to be verified the relation:

$$Molar content of K \geq molar content of Na$$

In particular, the most preferred molar ratios between the content in potassium and that one in sodium in the geopolymer (herein below also indicated merely as “GP”) of the invention are to be comprised preferable in the interval 50% K/50% Na÷90% K/10% Na.

Finally, though K and Na are the preferred alkali metals to be used in combination and within given ratios in the GP mixed system according to the invention, the use of other combinations of alkali metals pertaining to the same group (group 1) of the Periodic Table may be envisaged, as mentioned before. Moreover, since the essential aspect of the invention is the combination of at least two different alkali metals in the obtaining of the geopolymer, it is also included in the present Invention the joint use of more than two different alkali metals.

So it is part of the present invention any geopolymeric mixed system composed by a combination of at least two different GP having repeating units each corresponding to the general formula:

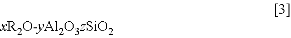

wherein R is preferably either K or Na, but may be any of Li, Na, K, Cs and Rb.

In general, a friction material block or layer according to the invention will present a binder matrix made of
Either an intimate mixture of at least two geopolymers having recursive units corresponding to the above formula [3] wherein R is either Na or K, or Li or Ce or Rb;
Or a single geopolymer having a mix (a combination) of recursive units corresponding to the above formula [3] wherein R is either Na or K, or Li or Ce or Rb, so that within the same geopolymer are present simultaneously at least two different alkali metals.

More in general, therefore, a friction material block or layer according to the invention will present a binder matrix consisting in a SiO₄ and AlO₄ tetrahedral frameworks linked by shared oxygens as poly(sialates) or poly(sialate-siloxo) or poly(sialate-disiloxo) depending on the SiO₂/Al2O₃ ratio in the system, containing a combination of different alkali metal aluminosilicates, preferably of K and Na with prevalence of K, the connection of the tetrahedral frameworks being occurred via long-range covalent and/or mixed (ionic-covalent bonds) bonds

### BRIEF DESCRIPTION OF DRAWINGS

This invention will now be described in more detail with reference to non-exhaustive and non-limiting practical examples of implementation thereof and with reference to the figures of the annexed drawings, in which;

FIG. 1 schematically illustrates an experimentally obtained state diagram of a three component system SiO₂—NaAlSiO₄—KAlSiO₄;

FIG. 2 illustrates schematically the same state diagram of the three component system SiO₂—NaAlSiO₄—KAlSiO₄ wherein a region of interest to obtain the mixed Na/K GP of the invention is delimited in a darker color;

FIGS. 3 and 4 show pictures of tapes of a GP according to the invention obtained after a tape casting operation of an aluminosilicate slurry at alkaline different molar concentrations;

FIG. 5 illustrates in a comparative manner IR spectra of geopolymers according to the invention obtained at different alkaline molar concentrations;

FIGS. 6 and 7 show pictures of different samples of geopolymeric binders molded as discs and after consolidation, in FIG. 7 the samples having been obtained at different K/Na ratios;

FIG. 8 schematically show graphics representing the rheology of the geopolymers/geopolymer precursors mixed system according to the invention at different molar concentration of alkali metal;

FIG. 9 schematically show graphics representing a comparison of volume densities after grinding of pure Na or K geopolymers (pure systems) and of a mixed K—Na geopolymer according to the invention;

FIG. 10 schematically show a bar diagram comparing the Young modulus of friction material blocks having a GP binder according to a pure system Na or K based and according to the mixed system K—Na of the invention;

FIGS. 11 and 12 show a selection of the most representative parts of the results of the same AK Master braking test carried out on brake pads produced according to the prior art and with a friction material according to the invention; and

FIG. 13 is an experimental graph showing a comparison of the trends in the friction coefficient during the same braking test carried out on brake pads commercial (as reference) and made with inorganic binders constituted by GP pure systems (Na and K) and by a mixed system K—Na.

### DETAILED DESCRIPTION

The examples and comparative examples are reported herein for purposes of illustration, and are not intended to limit the invention.

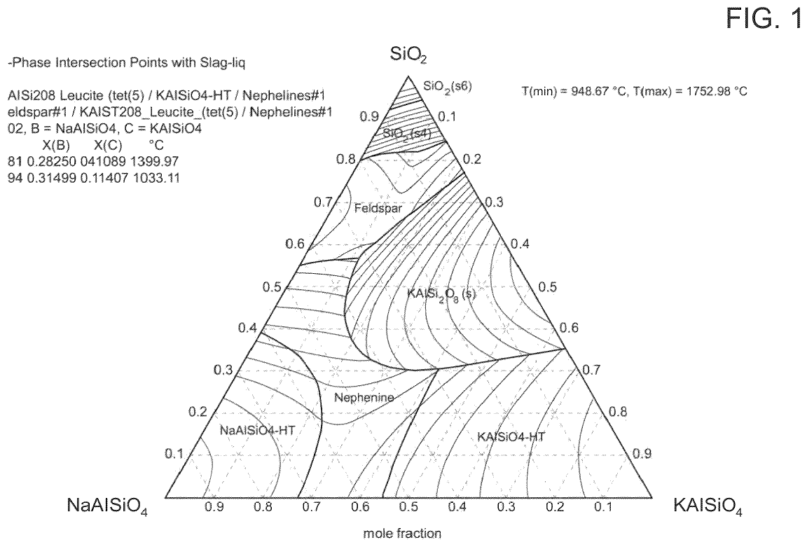

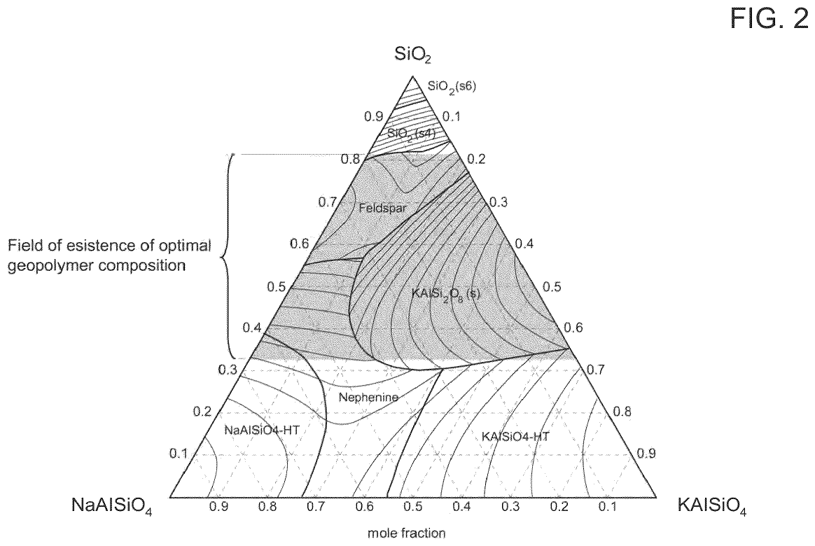

With reference to FIGS. 1 and 2, it is shown the state diagram of a complex three component system (“liquidus” temperature diagram), wherein the three vertex of the triangle representing conventionally the system correspond to a composition of 100% of SiO₂ (upper corner), 100% NaAlSiO₄ (bottom left corner) and 100% KAlSiO₄ (bottom right corner). Inside such a triangle there exist a number of different phases (indicated) having a mixed composition given for each point by target on the corresponding side of the triangle.

Starting from the finding that geopolymer systems previously provided by the present Applicant as e.g. per EP3841311, based on Na only as the alkali metal component, so positioned solely along the left side of the diagram, and eventually on geopolymers derived from systems based on K only as the alkali metal component, so positioned solely along the right side of the diagram, have proved to suffer from some drawbacks, like scarce workability for K based systems and scarce heat resistance for Na based systems, the technical people of the Applicant have decided, with no certainty of overcoming the drawbacks of the prior art, to anyway investigate the properties of a mixed Na—K system. Commercial Sodium-Potassium mixed silicate and metakaolin were mixed, or a three components geopolymeric reaction systems based on caustic silicates of both Na and K and metakaolin, so pertaining to the internal area of the state diagram of FIGS. 1 and 2, were prepared.

After a series of experiments that will be described herein below, the technical people of the Applicant have individuated the area within the state diagram of the three-phasic system of FIG. 1 which is highlighted in FIG. 2.

### METHOD ACCORDING TO THE INVENTION—OPERATIONAL EXAMPLES

Different silicate solution of sodium and potassium having different molar ratio (SiO₂/R2O) and water content, are used to produce mixed silicate solution having different molar contents in Na and K according to the following Table 1:

TABLE 1

| | | |
|---|---|---|
| 1M | 50% K | 50% Na |
| 2M | 62.5% K | 37.5% Na |
| 3M | 75% K | 25% Na |
| 4M | 87.5% K | 12.5% Na |

These alkaline solutions are separately mixed with commercial metakaolin using solution/metakaolin weight ratio between 1 and 10 (inclusive) for a Si/Al molar ratio in the range 1<x<10; preferably this range can vary from 2 to 6. Different ratios with a higher Al or Si content are also possible; however, the experimental results and theoretical calculations lead to the conclusion that the invention operates with maximum efficiency with a Si/Al ratio between 2 and 6.

The caustic silicate solutions and metakaolin are separately mixed through mechanical agitation, to obtain the formation of six homogeneous pastes.

The pastes thus obtained are separately spread onto different plastic mats using the “Tape Casting” technique to obtain tapes of 0.5 mm thickness and then dried in temperatures between 70-250° C. and under atmospheric pressure, in a time ranging between 1′ (minutes) and 90′ (minutes), to reduce the weight of the mixture by up to 10-40% of the original weight, and transform it into pure amorphous geopolymers.

The dried caustic silicates-metakaolin geopolymeric systems are removed from the drier and ground with a ball mill rotating at 400 RPM for 20 minutes. The final water contents are determined by considering the maximum quantity of water that the system is able to lose, to which corresponds a powder moisture of 0% and are set in order to have a residual humidity of the powders in the range of 9-10% w (by weight).

The geopolymer powders so produced are subdivided in fractions and each fraction for each different geopolymeric powder is:
used as such to produce a series of test sample molded in the shape of discs for 10 minutes at 150° C. and under a pressure of 20 MPa;
separately added to other raw materials required by the friction material mix or composition selected for dry mixing, using a known mixer, for example Loedige or Eirich. The mix or composition of the “green” friction material thus obtained is hot molded, under pressure, to obtain a series of brake pads. The molding stage is done by placing the raw or “green” compound and possibly a metallic support with a possible underlayer into a mold (known and not illustrated for simplicity) which is heated to a temperature between 6° and 250° C., submitting the raw compound to a molding pressure between 150 and 2000 Kg/cm2 for a time between 1 and 15 minutes, or pre-forming the raw compound 11 in a mold and then molding the pre-formed compound onto the metallic support, working at a temperature between 10° and 250° C. and with a molding pressure between 150 and 2000 kg/cm2 for a period between 1 to 15 minutes. Alternatively, the raw compound may be molded without a metallic support, so as to obtain only a block of friction material, which is then subsequently glued in a known manner to the metallic support, whether or not it has an insulator/dampener layer (known) or underlayer, using phenol- or silicon-based glues, e.g., pressing the block of friction material against the metallic support with the possible underlayer, operating at a temperature of 180° C. for 30 seconds. At the end of this process, an asbestos-free friction material is obtained, including as component materials inorganic and/or organic and/or metallic fibers, at least one binder, at least one friction modifier or lubricant, and at least one filler or abrasive, where the binder is constituted at least 90% by a silica-aluminum geopolymer perfectly consolidated.

With reference to the above, the component materials of the raw compound are added to the Inorganic binder in appropriate quantities such that the total quantity of inorganic geopolymeric binder is preferably but not necessarily equal to or greater than 20% in weight and not greater than 60% in weight of the entire volume of friction material and even more preferably equal to about 47% in weigh.

The at least one abrasive contained in the friction materials as described above is therefore, preferably but not necessarily, a medium or mild abrasive; where such terms refer to the following classification:
Mild Abrasives (with hardness of Mohs 1-3): e.g. talc, calcium hydroxide, potassium titanate, mica, vermiculite, kaolin;
Medium Abrasives (with hardness of Mohs 4-6): e.g. barium sulphate, magnesium oxide, calcium fluoride, calcium carbonate, wollastonite, calcium silicate, iron oxide, silica, chromite, zinc oxide;
Strong Abrasives (with hardness of Mohs 7-9): e.g. silicon carbide, zircon sand (zirconium oxide), zirconium silicate, zirconium, corundum, alumina, mullite.

The ratio in volume between the lubricants and the abrasives contained in the friction material to be formed is preferably selected between 1:1 and 1:4 (for comparison, this ratio is generally 1:8 or more in known friction materials with organic binder).

Furthermore, the starting raw materials for obtaining geopolymeric binder are selected such that the inorganic geopolymeric binder in the friction material according to the invention has a SiO₂/Al₂O₃ ratio between 3 and 10 and an SiO₂/Na₂O ratio between 3 and 10. The densification of the geopolymer powder is obtained during molding.

### Example 1—Comparative Production of Binders

In order to produce a geopolymer with a molar ratio Na:K=50:50, 150 g of Metakaolin from the company “Imerys Refractory Minerals” are mixed with 346 g of aqueous solutions of alkali silicates, (obtained by the mixing and dissolution of 133 g of solid sodium silicate “Britesil C335” supplied by “PQ Corporation” and 142.1 g of solid potassium silicate “205K” supplied by “Tillmanns”, with 7.68 g of sodium hydroxide and 9.99 g potassium hydroxide and 310.3 g of water). The mixing is done over a time varying from 5′ to 45′, at a speed of 800 rpm, using a drill agitator along with a specific mixing whisk for medium-high viscosity fluids in order to obtain four different geopolymeric precursor systems having different and controlled compositions. Varying the relative amount of solid silicates and hydroxides, it is possible to obtain the four relative Na:K composition describe in table 1.

The two reference systems Na-system and K-system are obtained according to EP3841311 and managed in the same manner as described therein. They will be used as benchmark binders for the evaluation of the properties of the mixed system.

Moreover, since K based systems are more alkaline, the increase in the relative content of K compared with Na brings to a denser material and to a progressive increase in the basicity of the solution too.

The wet pastes obtained are spread upon a sheet of Mylar, specific for wet and alkaline pastes/mortars using the following parameters: thickness of spread paste about 0.5 mm. Thereafter, multiple samples are prepared by drying the wet spread pastes at temperatures between 40° and 250° C., sheet sizes between A3 and A4, drying time variable between 1′ and 90′.

The sample binders in solid aggregate form are then separately detached from the sheets and ground with a ball grinder rotating at 400 turns/min, for 20 minutes, to bring the granulation of the product to obtain a powder of granulometry of about 400 microns or less.

Homogenous powders having a residual humidity of 4-16% w preferable of 6-12% w were obtained, weighted and pressed with standard parameters: 150° C.-20 MPa-10 min, in order to have the consolidation of the geopolymer.

Samples in the shape of discs were obtained and tested.

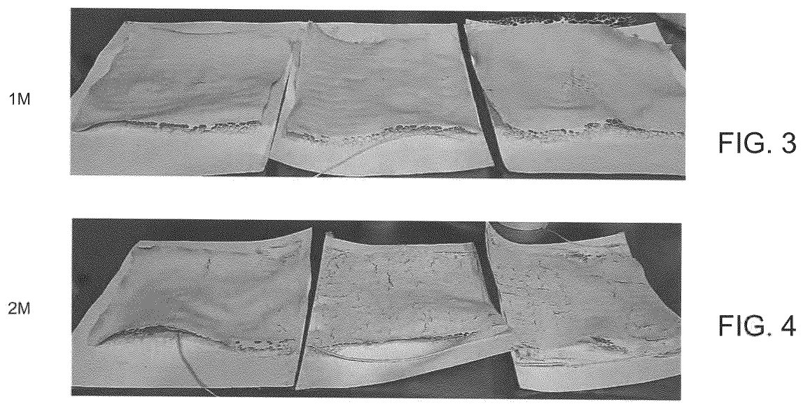

In FIGS. 3 and 4 pictures of the solid aggregate obtained in the form of tapes are shown for the mixed system labelled 1M and 2M. As it may be seen, the tapes are well formed and free of crakcs, so they can be handled easily, even when the relative content of K aluminosilicate is prevalent on that one of Na aluminosilicate. In conclusion, handling of the aggregates obtained with the mixed system Na—K is comparable to that one of pure Na systems.

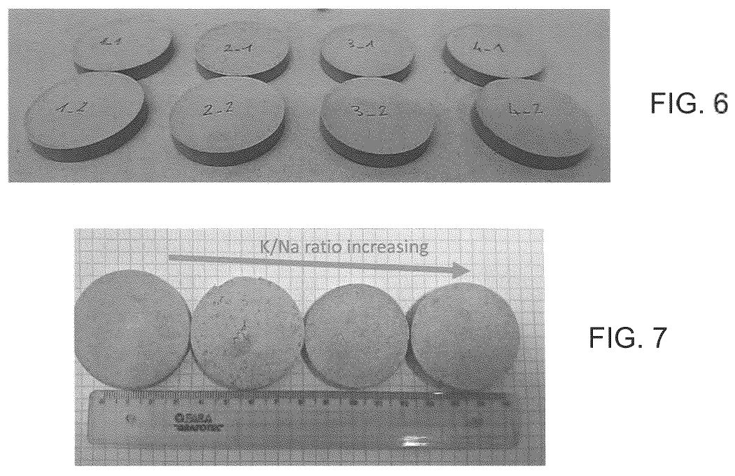

This is confirmed also in FIGS. 6 and 7, which show the aspect of the sample discs obtained by consolidation (carried out using the above indicated standard parameters of pressure and temperature) of the powders obtained from the solid aggregates corresponding to the mixed systems of Table 1, from 0.1M to 10M. All the discs are well formed and free of cracks. Moreover, the density of the sintered discs is increasing with the increase of the K content, as also reported in the following Table 2:

TABLE 2

| | Mean | St. Dev. |
|---|---|---|
| Comp | g/cm³ | g/cm³ |
| 1M | 2.118 | 0.001 |
| 2M | 2.137 | 0.001 |
| 3M | 2.128 | 0.001 |
| 4M | 2.159 | 0.002 |

The swelling phenomen due to the heating during the molding phase, typical of the Na systems, is almost completey absent in the mixed system samples (FIG. 7) and is more and more negligible with the increase of the K content. In any case, the phenomenon is limited to a slight increase in the disc diameter, as reported in the following Table 3 (Na-GP and K-GP being the benchmarks):

TABLE 3

| | Starting | Final | Diametral |
|---|---|---|---|
| | diameter (mm) | diameter (mm) | Swelling % |
| Na-GP | 40 | ≈52 | ≈30 |
| 1M 50-50 | 40 | ≈49 | ≈22.5 |
| 2M 62.5-37.5 | 40 | ≈46 | ≈15 |
| 3M 75-25 | 40 | ≈44 | ≈10 |
| 4M 87.5-12.5 | 40 | ≈43 | ≈7.5 |
| K-GP | 40 | ≈40 | ≈0 |

As it may be seen, while the pure Na-system disc (Na-GP) presents a diameter increase of about 30%; the mixed system Na—K discs present diameter increases progressively lower in response to an increase of the K molar content in the mixed Na—K system. A pure K system disc (K-GP) substantially presents no swelling, but may be fragile.

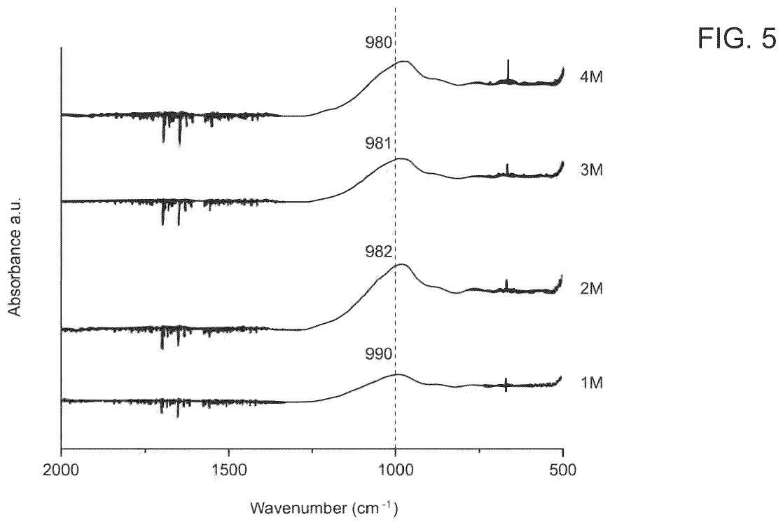

The powder obtained after the grinding phase from the residual material tape and before using it for forming the test discs has been subjected to an IR analysis and the relative results are reported in graphical form in FIG. 5.

As it may be seen, in all the mixed system powders it may be easily identified the presence of a geopolymer. The peak at around 1000 cm⁻¹ is of the Si—O bond. The confirmation of the ration is due to the fact that compared to the metakaolin where the peak is at 1030-1040 cm⁻¹, in the geopolymer the peak is below 1000 cm⁻¹, and the chemical shift is precisely due to the fact that aluminum participates in the continuous 3D network of the silica. This is evidence that all the systems from 1M to 4M undergone the desired chemical reaction, irrespective the relative molar quantity of K present in the slurry mix. The IR peak below 1000 cm⁻¹ confirms the geopolymerisation due to the chemical shift of Al incorporation into the Silica network.

It is evident however that decreasing the Si/Al ratio, a chemical shift may be observed, due to the higher effect of Al on the Si—O stretching energy.

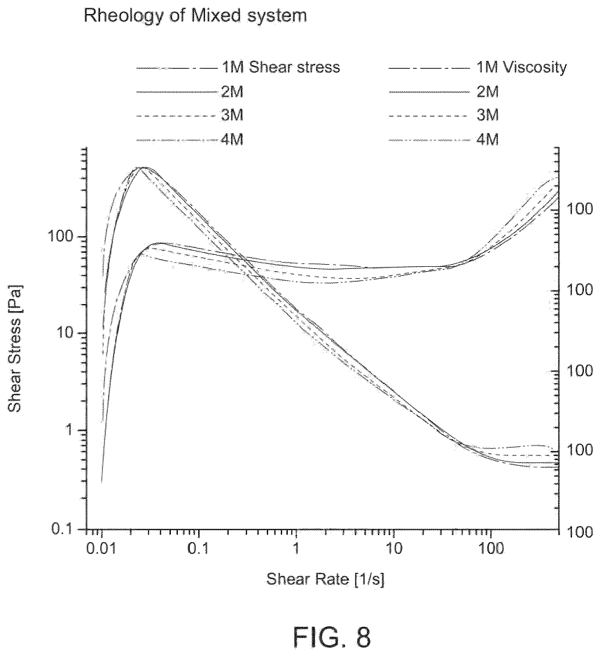

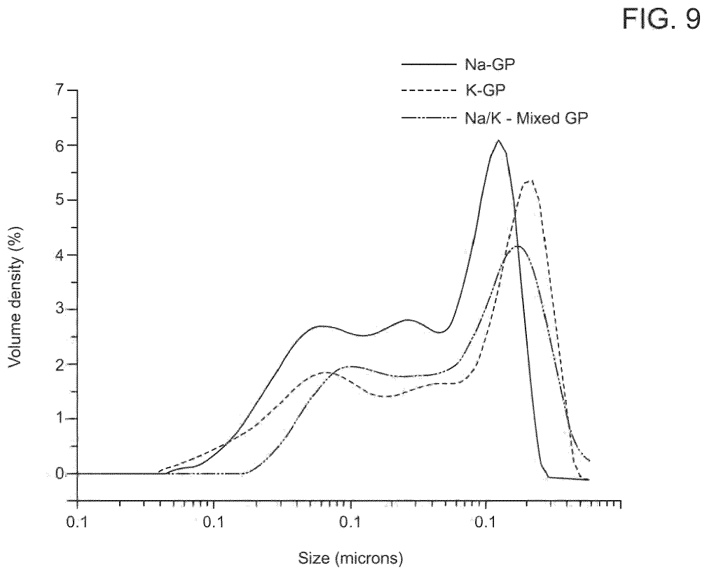

The powders obtained after the grinding phase from the residual material tape and before using it in the molding/consolidation phase in order to form the test discs have also been investigated in their granulometry composition. FIG. 9 shows a comparison between powders obtained after having undergone the same granulation or grinding phase in the same mill and derived from tapes cast from an Na-pure slurry system, a K-pure slurry system and a mixed Na—K slurry system. As it may be appreciated the physical properties of the powders derived from the different slurry systems are substantially the same, which is an important advantage for managing in the production phase these powders to obtain layers or blocks of friction material and manufacturing brake elements, lime brake pads or shoes. Finally, the mixing phase, carried out before the tape casting phase, has been also investigated during the execution thereof for all the four mixed systems of Table 2 and FIG. 8 shows the experimental results in the form of graphics reporting the measured shear stress versus the applied (by the mixing apparatus) shear rate. As it may be seen the (apparent) viscosity of all the four mixed system slurries 1M-4M are similar and follow the same trend, which is again an important process parameter, allowing to manage in the same manner, in an industrial production phase, the reaction slurry, irrespective of the relative quantity of K present.

### Example 2—Production of Brake Pads

A number of identical brake pads are produced using a known apparatus or plant, not illustrated for sake of simplicity.

Identical friction material formulations were prepared, using for each component the average value of the intervals reported in Table 4, below, and using as binder, indicated as “binder mix”, GP powders obtained according to example 1 starting from both pure Na and K systems and from each one of the four Na—K mixed systems, as shown in Table 1.

The GP powders having a humidity of 9% wt after production and grinding are used.

TABLE 4

| Component Materials | Geopolymeric Mix % Vol |
|---|---|
| Fibers | 8-25 |
| Friction Powders | 0.5-3 |
| Carbon | 8-20 |
| Rubbers | 1-4 |
| Medium Abrasive | 5-15 |
| Mild Abrasive | 9-12 |
| Sulfur | 3-10 |
| Inorganic Binder Mix | 20-60 |
| TOTAL | 100 |

The binder mix is added to the other ingredients of the mix according to a general scheme: binder 20-60% in weight, other components 40-80% in weight; the mix is done with a Loedige mixer. The GP system is the 47% wt of the friction mix.

Subsequently, the friction material mixes/compounds so obtained are molded in identical brake pads, placing the raw or “green” compound and a metallic support into one mold. Molding takes place by steps at temperatures of 100-150/70-135/70-135° C., subjecting the raw compound to a molding pressure of 250-720 Kg/cm2 for a time of 2-15 minutes.

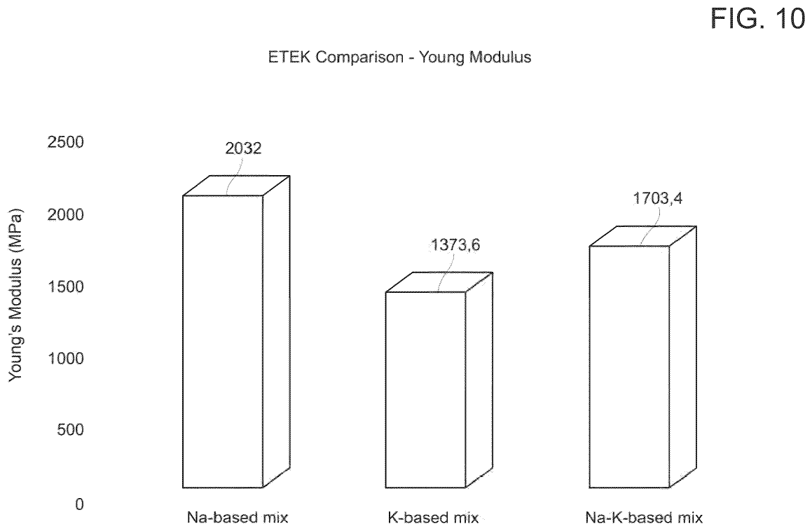

The friction material blocks so obtained are tested for their mechanical properties. The experimental results are reported in form of a bar graphic in FIG. 10, which compares the Young modulus of geopolymers obtained from a pure Na-system (Na-based mix), from a pure K-system (K-based mix) and from a mixed system (Na—K based mix—the reported value represent the average value, the Young modulus does not change too much with the variation of the K molar content). As it may be appreciated, the Young modulus of the mixed system GP is far better than that one of the pure-K system so ensuring better mechanical performances in use, close to those of GP obtained from the Na-pure system.

### Example 3—Braking Tests

The brake pads produced as described in example 2 were subjected to the following tests:

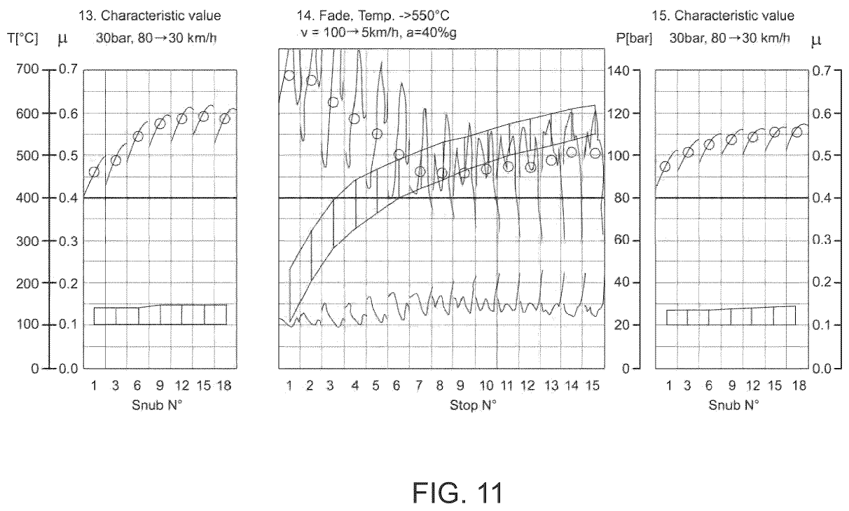

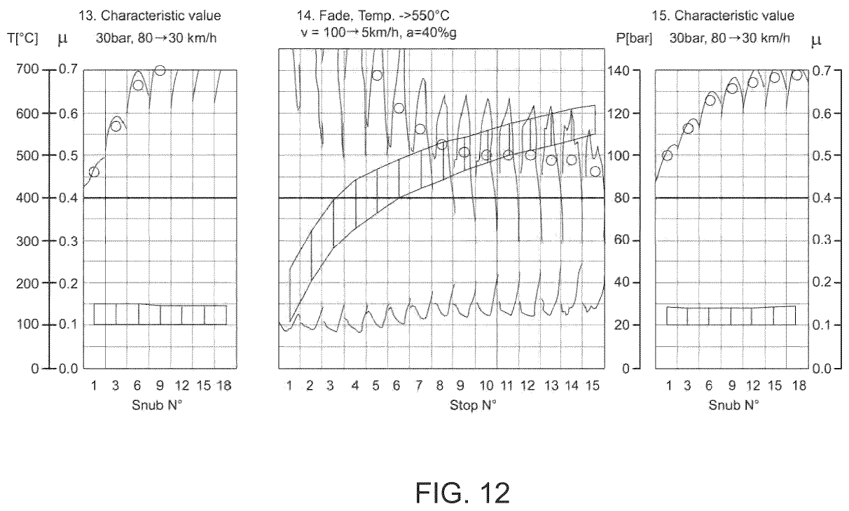

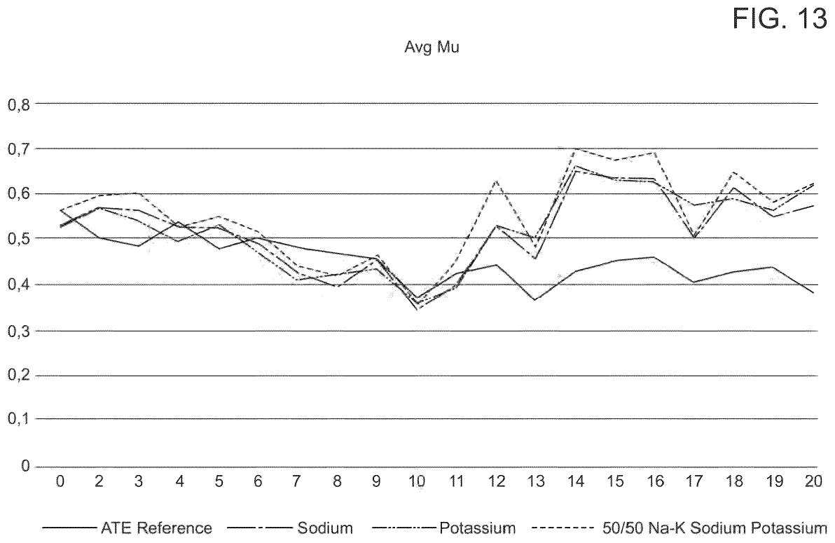

Efficiency Test according to AKM including: settlement braking, braking at different fluid pressures, cold (<50° C.) assessment braking, simulated highway braking, two high-energy braking (first FADE test) series interspersed with a regenerative braking series. From this test it is also possible to extrapolate, using methods known to industry technicians, the wear to which the brake pad and disc are subjected. An extract of the results obtained is illustrated in FIGS. 11 and 12, which schematically represent the most significant data of the experimental curves obtained. The graphs of FIG. 11 relate to the above AKM test carried out on a brake pad equipped with a friction material according to Table 5 wherein the Inorganic binder mix consists of a powder derived from the pure-Na system, i.e. composed by a GP containing solely Na aluminosilicates, i.e. based on the Na-system of Table 2, while FIG. 12 refers to the same test carried out on brake pads with a friction material according to Table 5, wherein the inorganic binder mix consists of a powder derived from the 1M mixed system, i.e. composed by a GP containing a molar ratio 1:1 of K and Na, i.e. based on a 50% Na/50% K mixed system (1M). The graphs are self-explanator.

As can be seen, the experimental AKM results for the braking properties are very similar and completely comparable (when not better) with those of the benchmark samples obtained according to EP3841311. Table 5 below shows the results of a wear comparative test carried out on the brake pads equipped with the friction material of the tests of FIGS. 9 and 10.

TABLE 5

| | PAD WEAR | | | | |
|---|---|---|---|---|---|
| | Inner | | Outer | DISC WEAR | |
| Reference A | | | | | |
| Na-based system | | | | | |
| | 0.50 | mm | 0.51 | 4.7 | g |
| | 4.8 | g | 4.7 | | |
| Reference B | | | | | |
| 1M mixed system - | | | | | |
| 50% Na-50% K | | | | | |
| | 0.33 | mm | 0.36 | 4.8 | g |
| | 4.6 | g | 5.1 | | |

As it can be seen also the wear is similar to the prior art (pure Na-based system), even if the pads according to the invention are less subject to reduction in thickness even if having a comparable loss of weight, due to a better compactness.

A further braking test has been carried out on brake pads produced with the both the two GP materials of the prior art (EP3841311) and with the GP material of the invention made according to the reaction system mix 1M as listed in Table 2. The test steps are reported herein below with the corresponding results in Table 6.

TABLE 6

| | | | | 50/50 |
|---|---|---|---|---|
| | | | | Na—K Sodium |
| | Cycle | Sodium | Potassium | Potassium |
| 1 | Settlement 1[med] | 0.534 | 0.532 | 0.568 |
| 2 | Settlement 2[med] | 0.575 | 0.574 | 0.602 |
| 3 | Efficiency 1[med] | 0.568 | 0.547 | 0.607 |
| 4 | Pressure 40 km/h[med] | 0.533 | 0.499 | 0.533 |
| 5 | Pressure 80 km/h[med] | 0.531 | 0.534 | 0.557 |
| 6 | Pressure 120 km/h[med] | 0.497 | 0.473 | 0.523 |
| 7 | Pressure 160 km/h[med] | 0.431 | 0.417 | 0.447 |
| 8 | Pressure 180/200 km/h[med] | 0.401 | 0.427 | 0.426 |
| 9 | Efficiency 2[med] | 0.462 | 0.442 | 0.474 |
| 10 | Braking 40°[med] | 0.35 | 0.367 | 0.362 |
| 11 | Motorway (set 90% maxspeed | 0.407 | 0.401 | 0.461 |
| | and 50% finalspeed)[med] | | | |
| 12 | Efficiency 3[med] | 0.539 | 0.538 | 0.638 |
| 13 | FADE 1[med] | 0.464 | 0.509 | 0.491 |
| 14 | Efficiency 4[med] | 0.658 | 0.67 | 0.709 |
| 15 | Pressure 100°[med] | 0.645 | 0.64 | 0.683 |
| 16 | Climb 500°[med] | 0.643 | 0.635 | 0.698 |
| 17 | Pressure 500°[med] | 0.514 | 0.586 | 0.519 |
| 18 | Efficiency 5[med] | 0.624 | 0.598 | 0.659 |
| 19 | FADE 2[med] | 0.56 | 0.578 | 0.593 |
| 20 | Efficiency 6[med] | 0.586 | 0.631 | 0.636 |

### Example 4—Judder Tests

The brake pads produced in example 2 were mounted on a vehicle (motor car) and compared with commercial brake pads of the same dimension (the original ones of the test car—NAO material). The results are reported in Table 7. The comparison has been carried out with a geopolymeric mixed system 50% Na-50% K.

TABLE 7

| | | Judder(average) | rating min | Only rear(average) | rating min |
|---|---|---|---|---|---|
| | | during 5 | during 5 | 2 br. appl. only | 2 br. appl. only |
| | | blocks | blocks | with RA | with RA |
| Test 1 | Commercial | 9.4 | 8 | 7 | 6 |
| Test2 | Na—K based mix | 9.3 | 8 | 6.5 | 6 |
| Test4 | K-based mix | 9.2 | 8 | 8 | 7 |
| Test6 | Na-based mix | [symbol] | [symbol] | [symbol] | [symbol] |

[symbol]

indicates data missing or illegible when filed

As it may be seen, the brake pads produced with the mixed GP system give results comparable with those produced with pure-K GP system and very similar to the common NAO brake pads currently in use; on the contrary, the brake pads produced with the pure-Na GP system are more subjected to judder.

In the end, it may be concluded that tuning the alkali ratio Na/K, (or in general an R1/R2 ratio wherein R1,R2 are any of Li, Na, K, Cs, Rb), it is possible to tune the properties of GP based (as binder) brake pads and to surprisingly combine the favorable aspects of both the pure (Na and K) systems:
Optimal tape production typical of sodium based GP systems
Optimal swelling behavior typical of potassium based GP systems

The rheology for pure Na, K systems or for the hybrid system appear to be similar also because the amount of silica is dependent on the relative amount of alkalis and water. In fact, with the same molar ratios, potassium-based systems are more fluid. This is why potassium requires less silica and less water than sodium to have similar viscosities; so the tape formation from the slurry is not affected.

It is moreover evident that the other properties can be tuned working on the friction formulation in order to respect the requirements of the brake pads, in particular in term of AKM and judder performances.

All the aims of the present invention are therefore fulfilled.

### Certain Terminology

Although certain braking devices, systems, and methods have been disclosed in the context of certain example embodiments, it will be understood by those skilled in the art that the scope of this . . . disclosure extends beyond the specifically disclosed embodiments to other alternative embodiments and/or uses of the embodiments and certain modifications and equivalents thereof, like brake shows for braking systems based on brake drums. Use with any structure is expressly within the scope of this invention. Various features and aspects of the disclosed embodiments can be combined with or substituted for one another in order to form varying modes of the assembly. The scope of this disclosure should not be limited by the particular disclosed embodiments described herein.

Conditional language, such as “can,” “could,” “might,” or “may,” unless specifically stated otherwise, or otherwise understood within the context as used, is generally intended to convey that certain embodiments include or do not Include, certain features, elements, and/or steps. Thus, such conditional language is not generally intended to imply that features, elements, and/or steps are in any way required for one or more embodiments.

Unless stated otherwise, the terms “approximately,” “about,” and “substantially” as used herein represent an amount close to the stated amount that still performs a desired function or achieves desired result. For example, in some embodiments, as the context may dictate, the terms “approximately”, “about”, and “substantially” may refer to an amount that is within less than or equal to 10% of the stated amount. Likewise, the term “generally” as used herein represents a value, amount, or characteristic that predominantly includes or tends toward a particular value, amount, or characteristic.

This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

1. An asbestos free friction material configured for production of brake elements, the friction material comprising:
inorganic and/or organic and/or metallic fibers;
at least one binder;
at least one friction modifier or lubricant; and
at least one filler or abrasive, wherein
the binder is almost completely or completely and exclusively inorganic,
the binder is made up of at least 90% w of at least one amorphous geopolymer or of a mixture of amorphous geopolymers,
the at least one amorphous geopolymer or mixture of geopolymers contain aluminosilicates including in combination at least two different alkali metals, and
the alkali metals are selected as pairs of different metals from the group consisting of: Na, K, Li, Ce, Rb.

2. The asbestos free friction material according to claim 1, wherein the at least one amorphous geopolymer or mixture of geopolymers are been derived from a source of alumina (Al₂O₃) preferably metakaolin, and from a simultaneous combination of potassium and sodium silicates.

3. The asbestos free friction material according to claim 2, wherein the relative molar content of potassium (K) is equal to or greater than the relative molar content of sodium (Na):
molar content K≥molar content Na.

4. The asbestos free friction material according to claim 3, wherein the molar ratio between potassium (K) and sodium (Na) is 1:1.

5. The asbestos free friction material according to claim 3, wherein the molar ratios between the content in potassium and in sodium in the at least one amorphous geopolymer or mixture of geopolymers are comprised in the interval 50% K/50% Na÷90% K/10% Na.

6. The asbestos free friction material according to claim 1, wherein the at least one binder is made up of at least 90% w of a geopolymeric mixed system composed of
i)—a combination of at least two different geopolymers having repeating units each corresponding to the general formula: 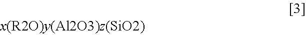
or
ii)—a single geopolymer containing a combination of at least two different repeating units having the general formula [3], wherein R is different in said at least two different repeating units;
and wherein
iii) R is any of Li, Na, K, Cs and Rb and preferably is either K or Na in each repeating unit.

7. The asbestos free friction material according to claim 1, wherein the molar ratio between the alkali metals content and the aluminum content in the geopolymers is equal to 1, as verified by the formula:
$$R / Al = 0.8 < x < 1.2 \qquad [ {1}^{′} ]$$

8. A friction material block or layer for brake elements, comprising:
a binder matrix consisting of up to 90% w of a SiO₄ and AlO₄ tetrahedral structures linked by shared oxygens as poly(sialates) or poly(sialate-siloxo) or poly(sialate-disiloxo) depending on the SiO₂/Al₂O₃ ratio, and containing a combination of at least two different alkali metal aluminosilicates.

9. A brake pad for vehicles comprising a block or layer of a friction material, wherein the block or layer of the friction material comprises:
a binder matrix consisting of up to 90% w of a SiO₄ and AlO₄ tetrahedral structures linked by shared oxygens as poly(sialates) or poly(sialate-siloxo) or poly(sialate-disiloxo) depending on the SiO₂/Al₂O₃ ratio, and containing a combination of at least two different alkali metal aluminosilicates.

10. A method for manufacturing a friction material and friction layers or blocks made therefrom to be applied to friction elements, the method comprising the steps of:
a) preparing a wet paste formed by mixing an alkaline silicate solution with a material selected in the group consisting of metakaolin, kaolin, fly ash, mixtures thereof, the wet paste constituting an alkaline geopolymer reaction system,
b) spreading the wet paste on a support to form a layer or tape,
c) drying the wet paste to obtain a geopolymer aggregate,
d) grinding the geopolymer aggregate to a powder;
e) using the ground powder as an inorganic binder in a friction material compound by mixing the ground powder with inorganic and/or organic and/or metallic fibers, with at least one friction modifier or lubricant and with at least one filler or abrasive, so as obtain a raw frictional material compound having as binder almost exclusively or exclusively said ground geopolymeric aggregate;
f) hot molding between 40° C. and 300° C. the raw friction material compound to obtain a block of friction material having at least 90% w geopolymer as binder, wherein
the step a) is carried out by using simultaneously, in combination, at least two different alkali silicates.

11. The method of claim 10, wherein
in step a), the molar ratio between potassium (K) and sodium (Na) is in the interval 50% K/50% Na÷90% K/10% Na; and
the molar ratio between the Na/K metals content and the aluminum content in the geopolymer system is equal to 1.

12. (canceled)

13. The friction material block or layer for brake elements according to claim 8, wherein the binder matrix contains aluminosilicates of K and Na with a prevalence of K aluminosilicate.

14. The brake pad for vehicles according to claim 9, wherein the binder matrix contains aluminosilicates of K and Na with a prevalence of K aluminosilicate.

15. The method according to claim 10, wherein the at least two different alkali silicates include sodium and potassium silicates with the addition of a small quantity of sodium and/or potassium hydroxide.
